(19) United States
(12) Patent Application Publication
(10) Pub. No.: US 2013/0134025 A1
(43) Pub. Date: May 30, 2013

(54) RESISTIVE TOUCH DISPLAY PANEL HAVING ANTI-SCRAPE LAYER

(71) Applicants: YUNG-TENG WU, NEW TAIPEI CITY (TW); CHUAN-HSIUNG LI, NEW TAIPEI CITY (TW)

(72) Inventors: YUNG-TENG WU, NEW TAIPEI CITY (TW); CHUAN-HSIUNG LI, NEW TAIPEI CITY (TW)

(73) Assignee: CRETE SYSTEMS INC., NEW TAIPEI CITY (TW)

(21) Appl. No.: 13/400,817

(22) Filed: Feb. 21, 2012

(30) Foreign Application Priority Data
Nov. 24, 2011 (TW) 100222292

(51) Int. Cl. H01H 1/10

(52) U.S. Cl. 200/512

(57) ABSTRACT

The present invention relates to a resistive touch display panel having anti-scrape layer, which comprises a display apparatus, a first transparent substrate, an adhesive layer, a second transparent substrate, and an anti-scrape layer. The first transparent substrate is disposed on the display apparatus. The adhesive layer is disposed on the first transparent substrate and has an outer periphery. The second transparent substrate is disposed on the adhesive layer. An outer edge of the anti-scrape layer is disposed on the second transparent substrate opposite to the outer periphery. Besides, the outer edge is located inside the outer periphery. Thereby, the internal structure is free from scrapes; the touch sensitivity at the periphery of the touch display panel is improved. Accordingly, superior convenience in usage and practicability can be achieved.

### FIELD OF THE INVENTION

The present invention relates generally to a display panel, and particularly to a resistive touch display panel having anti-scrap layer.

### BACKGROUND OF THE INVENTION

As the era advances increasingly, electronic devices become more convenient in usage, and thereby people rely more on electronic devices. The usage of tablet computers, notebook computers, cell phones, personal digital assistants, automatic teller machines, and other electronic devices having displays increases drastically daily. In addition, thanks to its friendly interface for operation, touch panels have been applied widely in various electronic products having displays. Because the quantities of the products for portable communications and consumer electronics increase day by day and such products adopt considerable quantities of touch panels as their input devices, many practitioners in business involve in the related technical development of touch panels.

Touch panels are widely applied to the surface of liquid crystal displays (LCDs), plasma display panels (PDPs), field-emission displays (FEDs), electroluminescent displays (ELDs), or cathode-ray tubes (CRTs) so that users can perform functions such as selecting or inputting by their fingers or styli following the instructions on the displays. Depending on their operational principles, touch panels can be categorized into resistive, capacitive, acoustic, wave-guide, load variation touch panels, where resistive and capacitive touch panels are most adopted.

The resistive touch panel according to the prior art comprises two plates of transparent conductive films spaced by a fixed gap and disposed oppositely. The top transparent conductive film is disposed on a surface of a flexible transparent thin film; the bottom transparent conductive film is disposed on a surface of a glass substrate of hard material. Then an adhesive material is used for sealing and adhering the edges of the two transparent conductive films and forming a gap therebetween. Besides, the bottom transparent conductive film has spaced spacers made of insulating spacer material. A fixed voltage is then applied between the top and bottom transparent conductive films. When fingers, styli, or other media touch the surface of the touch panel, pressure is applied to the top transparent conductive film, making the electrodes of the top and bottom transparent conductive films contact and produce voltage variations. Then a controller converts the variations into digital signals and the computer operates and gives the location coordinates. Thus, the data of the contact point is given.

To conclude, although resistive touch panels are very convenient, transparent thin films (PET thin films) are vulnerable to scrapes by objects, and hence leading to open circuit between transparent conductive films and disabling the touch panels from normal operations. Thereby, according to the prior art, a glass anti-scrape layer is added on the transparent film for protecting the transparent thin film from scrapes. Nonetheless, a general glass anti-scrape layer covers the transparent thin film completely. Namely, the glass anti-scrape layer presses and attaches to the adhesive contact. In order to protect the transparent thin film, the thickness of the glass anti-scrape layer is thicker than the PET thin film. In addition, the hardness of the glass anti-scrape layer is greater. When disposing the glass anti-scrape layer, the surface thickness will increase. Because the glass anti-scrape layer presses and attaches to the adhesive contact, while touching the touch panel, its response will be less sensitive. Alternatively, a larger touch force (greater stress) should be applied to make the edges of the top transparent conductive film touch the bottom transparent conductive film. After long-term usage, the portion tends to be damaged.

Take Taiwanese Patent Publication Number M344521 for example. The invention provides a touch panel having anti-scrape touch surface comprising a bottom conductive layer, a top conductive layer, a spacer layer between the top and bottom conductive layers, and a flexible printed-circuit board connected to the sides of the bottom and top conductive layers. A glass layer is disposed on the top conductive layer. By taking advantage of the harder glass layer than the plastic protection layer on the surface of a general touch panel, the anti-scrape capability of the touch panel can be improved. Nonetheless, as described above, this structure has the problem of insensitivity at the edges or even of no response to the applied force.

Thereby, how to break through and solve the problems in the prior art and improve convenience, practicability, and economic effect have come the major subject for practitioners in the business.

Accordingly, the present invention solves the problems and nonideal structural designs in the resistive touch panels according to the prior art, and provides a resistive touch display panel having anti-scrape layer for enhancing convenience, practicability, and economic effect, and thus serving the general public as well as promoting development of the industry.

### SUMMARY

An objective of the present invention is to provide a resistive touch display panel having anti-scrape layer, which can enhance the touch sensitivity of a touch display panel.

Another objective of the present invention is to provide a resistive touch display panel having anti-scrape layer, which can avoid scrapes of a panel and increase the lifetime of a touch display panel.

Still another objective of the present invention is to provide a resistive touch display panel having anti-scrape layer, which can reduce the applied force by a user and hence increasing operational convenience.

In order to achieve the objectives and effects described above, the present invention comprises a display apparatus, a first transparent substrate, an adhesive layer, a second transparent substrate, and an anti-scrape layer. The first transparent substrate is disposed on the display apparatus. The adhesive layer is disposed on the first transparent substrate and has an outer periphery. The second transparent substrate is disposed on the adhesive layer and opposite to the first transparent substrate. An outer edge of the anti-scrape layer is disposed on the second transparent substrate opposite to the outer periphery. Besides, the outer edge is located inside the outer periphery.

### BRIEF DESCRIPTION OF THE DRAWINGS

FIG. 1 shows a cross-sectional view according to a preferred embodiment of the present invention;

FIG. 2 shows a three-dimensional exploded view according a preferred embodiment of the present invention;

FIG. 3 shows an operational schematic diagram according to a preferred embodiment of the present invention;

FIG. 4 shows a partial cross-sectional view according another preferred embodiment of the present invention; and

FIG. 5 shows a partial cross-sectional view according another preferred embodiment of the present invention.

### DETAILED DESCRIPTION

In order to make the structure and characteristics as well as the effectiveness of the present invention to be further understood and recognized, the detailed description of the present invention is provided as follows along with embodiments and accompanying figures.

According to the touch display panels according to the prior art, their anti-scrape glass covers the adhesive layer completely, resulting in uneasy presses at the periphery of the anti-scrape glass. Thereby, presses at the periphery are insensitive and need more force. In addition, damages may occur on the materials at the periphery. The present invention solves the drawbacks and provides a touch display panel for achieving convenience.

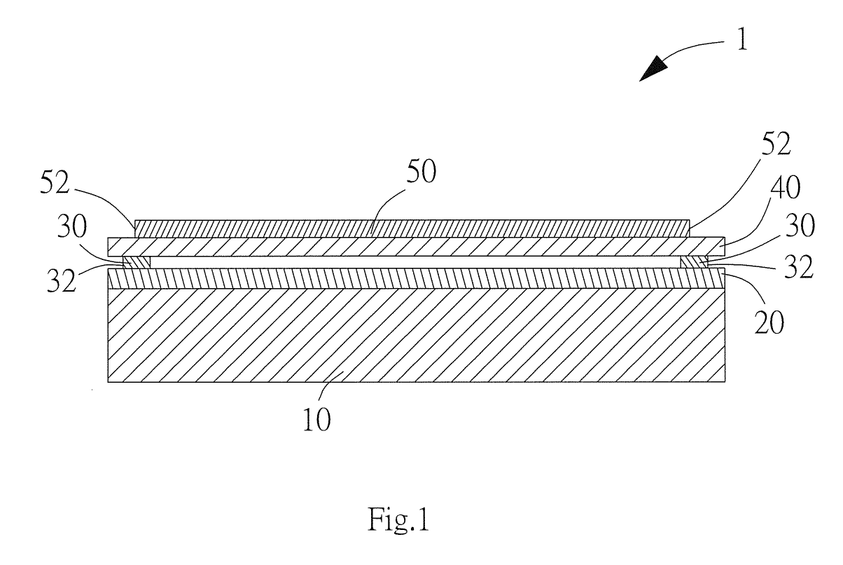

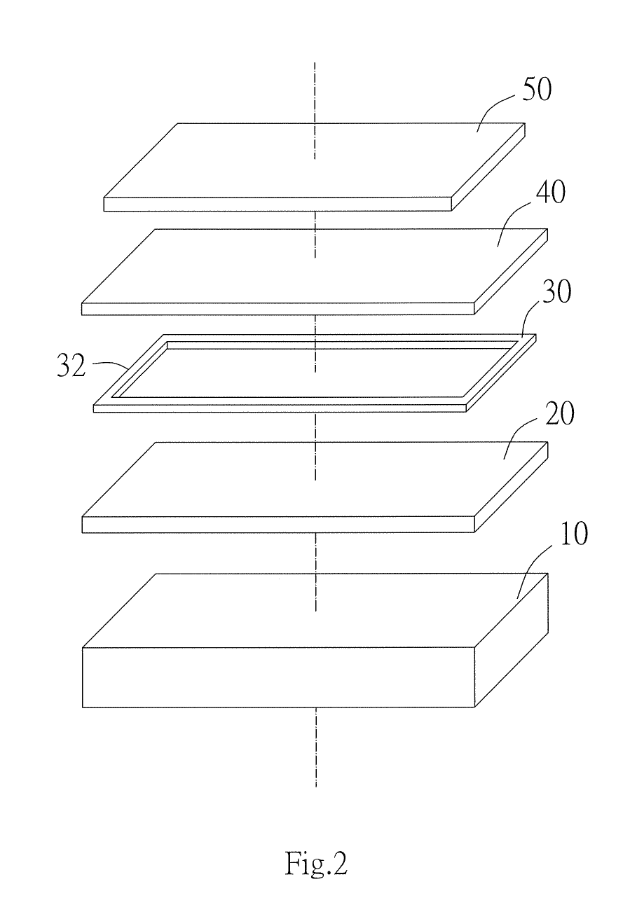

FIGS. 1 and 2 show a cross-sectional view and a three-dimensional exploded view of the resistive touch display panel having anti-scrape layer according to a preferred embodiment of the present invention. As shown in the figures, a touch display panel 1 according to the present invention comprises a display apparatus 10, a first transparent substrate 20, an adhesive layer 30, a second transparent substrate 40, and an anti-scrape layer 50. In addition, the adhesive layer 30 has an outer periphery 32.

First, the first transparent substrate 20 is disposed on the display apparatus 10. Then the adhesive layer 30 is disposed on the periphery of the surface of the first transparent substrate 20. According to the present embodiment, the adhesive layer 30 is rectangular. However, other shapes can be also adopted. The adhesive layer 30 includes the outer periphery 32. Next, the second transparent substrate 40 is disposed on the adhesive layer 30 and opposite to the first transparent substrate 20. Thereby, the periphery of the second transparent substrate 40 can be connected with the periphery of the first transparent substrate 20. Besides, because the adhesive layer 30 has a fixed thickness, it can separate the first transparent substrate 20 from the second transparent substrate 40 by a certain zoom. Finally, an outer edge 52 of the anti-scrape layer 50 is disposed on the second transparent substrate 40 opposite to and located inside the outer periphery 32. The anti-scrape layer 50 is used for protecting the second transparent substrate 40 from scrapes or other damages. The anti-scrape layer 50 can be a hard plastic layer, an anti-scrape glass layer, or other hard coating layers.

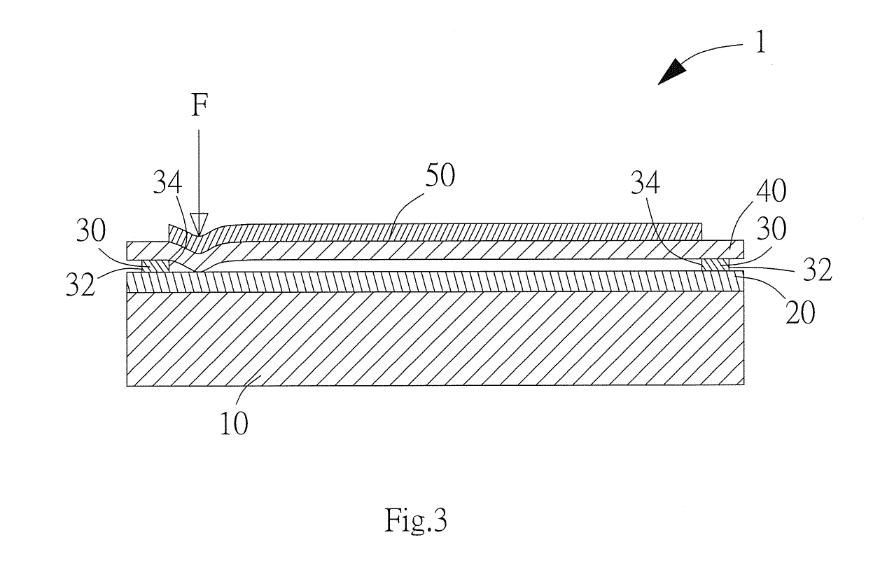

FIG. 3 shows an operational schematic diagram according to a preferred embodiment of the present invention. According to the present embodiment, a fixed voltage is applied across the first transparent substrate 20 and the second transparent substrate 40. When an external force F, such as the force by fingers, styli, or other media, presses the anti-scrape layer 50, the anti-scrape layer 50 and the second transparent substrate 40 are recessed. When the second transparent substrate 40 touches the first transparent substrate 20, variation in voltage occurs at the pressed location. Accordingly, the location coordinates are acquired, and thus giving the data of the contact point and completing selecting, inputting, or other functions. The adhesive layer 30 further has an inner periphery 34 located inside the outer periphery 32. In general, the interior zone of the inner periphery 34 can be a viewable zone. According to the present embodiment, the outer edge 52 of the anti-scrape layer 50 is located inside the outer periphery 32. In addition, it is preferred that the outer edge 52 of the anti-scrape layer 50 aligns the inner periphery 34 of the adhesive layer 30 (as shown in FIG. 3). In other words, the more the outer edge 52 is close to the inner periphery 34 of the adhesive layer 30, the greater the effect will be. Thereby, the stress near the adhesive layer 30 is reduced. Consequently, the situation in which the edge of the anti-scrape layer 50 is difficult to be pressed can be avoided. Besides, presses at the periphery of the touchable zone are more sensitive, requiring no extra force and hence preventing damages of the material at the periphery. Accordingly, the lifetime of the touch display panel 1 can be enhanced.

Nonetheless, the transparent thin film (PET thin film) on a general touch display according to the prior art are vulnerable to scrapes by objects, and hence leading to open circuit between transparent conductive films. Thereby, a glass anti-scrape layer is added on the touch panel (transparent film). The glass anti-scrape film has the same size as the transparent conductive film. It can also press on the adhesive layer (aligned or over). Thereby, the pressed stress will be over at the periphery, and hence producing the problem of insensitive presses at the periphery. The anti-scrape layer 50 according to the present embodiment can improve this problem and making the touches more sensitive, users' operations more convenient, the force required for touches lowered, users' burden reduced, and convenience enhanced. In addition, the consumption of the material for the anti-scrape layer 50 is reduced, and thus lowering the manufacturing cost.

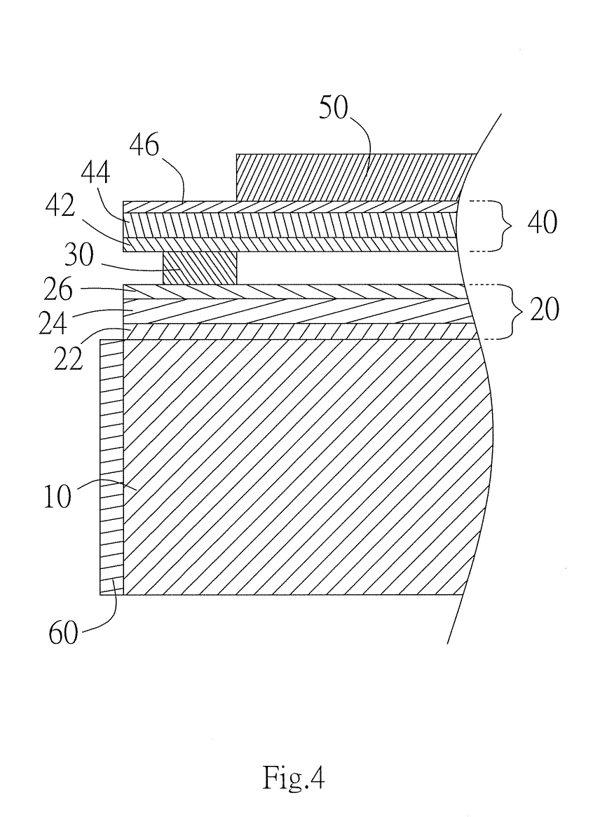

FIG. 4 shows a partial cross-sectional view of the resistive touch display panel having anti-scrape layer according another preferred embodiment of the present invention. As shown in the figure, the present embodiment is based on the structure and modified according to the embodiment described above. The first transparent substrate 20 comprises a glass substrate 22, a first circuit layer 24, and a first conductive film 26. The second transparent substrate 40 comprises a second conductive film 42, a second circuit layer 44, and a protection film 46. Besides, a controller 60 is disposed on one side of the display apparatus 10.

The glass substrate 22 described above is disposed on the display apparatus 10, which can be a thin-film-transistor display. The first circuit layer 24 is disposed on the glass substrate 22. Then the first conductive film 26 is disposed on the first circuit layer 24. Next, the adhesive layer 30 is disposed at the periphery of the first conductive film 26 and the second conductive film 42 is disposed on the adhesive layer 30. Afterwards, the second circuit layer 44 is disposed on the second conductive film 42; and the protection film 46 is disposed on the second circuit layer 44. The protection film 46 can be a PET thin film used for protecting the interior structure. At last, the anti-scrape layer 50 is disposed on the protection film 46. The thickness of the anti-scrape layer 50 can be 0.2 mm The controller 60 is connected electrically to the first circuit layer 24 of the first transparent substrate 20 and the second circuit layer 44 of the second transparent substrate 40.

According to the present embodiment, a fixed voltage is applied across the first conductive film 26 and the second conductive film 42. When an external force presses the anti-scrape layer 50, the anti-scrape layer 50 and the second transparent substrate 40 are recessed. When the first conductive film 26 touches the second conductive film 42, variation in voltage occurs at the pressed location. The first and second circuit layers 24, 44 can pass this message to the controller 60, which can judge the location and coordinates. Accordingly, selecting, inputting, or other functions can be performed.

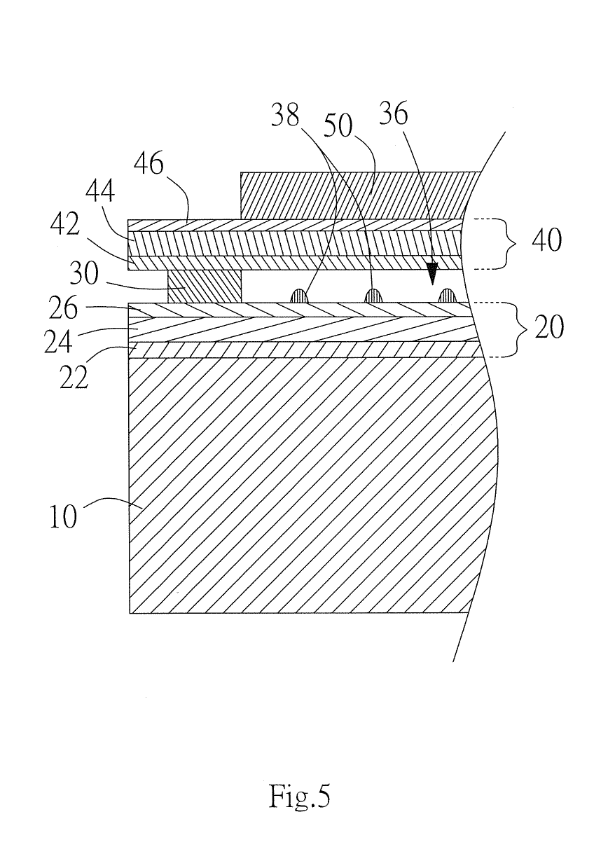

FIG. 5 shows a partial cross-sectional view of the resistive touch display panel having anti-scrape layer according another preferred embodiment of the present invention. As shown in the figure, the present embodiment is based on the structure and modified according to the embodiment described above. By means of the adhesion and support of the adhesive layer 30, a spacing zoom 36 is formed between the first and second transparent substrates 20, 40. In addition, the present invention further comprises a plurality of spacers 38 disposed on the first conductive film of the second transparent substrate 20 and contained in the spacing zoom 36. The plurality of spacers 38 can be transparent spacing dots arranged in order. When the panel is touches, by means of the plurality of spacers 38, a more precise location can be given. Namely, while touching, the plurality of spacers 38 can prevent the first conductive film 26 at the non-touched points near the touched point from contacting the second conductive film 42. Thereby, coordinates that are more precise can be given, which makes the accessed location more accurate.

By using the structure described above, no matter the user uses his finger or a stylus to operate the touch panel, scrapes on the anti-scrape layer 50 can be avoided even under frequent contacts and the internal structure can be protected. Moreover, by means of the special design of the anti-scrape layer 50, the touch sensitivity at the periphery of the touch display panel can be improved and thus enhancing convenience in usage.

Accordingly, the present invention conforms to the legal requirements owing to its novelty, nonobviousness, and utility. However, the foregoing description is only embodiments of the present invention, not used to limit the scope and range of the present invention. Those equivalent changes or modifications made according to the shape, structure, feature, or spirit described in the claims of the present invention are included in the appended claims of the present invention.

What is claimed is:

1. A resistive touch display panel having anti-scrape layer, comprising:
a display apparatus;
a first transparent substrate, disposed on said display apparatus;
an adhesive layer, disposed on said first transparent substrate, and having an outer periphery;
a second transparent substrate, disposed on said adhesive layer, and opposite to said first transparent substrate; and
an anti-scrape layer, an outer edge of said anti-scrape layer disposed on said second transparent substrate and opposite to said outer periphery, and said edge located inside said outer periphery.

2. The resistive touch display panel having anti-scrape layer of claim 1, wherein said adhesive layer has an inner periphery disposed inside said outer periphery.

3. The resistive touch display panel having anti-scrape layer of claim 2, wherein said outer edge of said anti-scrape layer aligns the inner periphery of said adhesive layer.

4. The resistive touch display panel having anti-scrape layer of claim 1, wherein the thickness of said anti-scrape layer is 0.2 mm.

5. The resistive touch display panel having anti-scrape layer of claim 1, wherein said display apparatus is a thin-film-transistor display.

6. The resistive touch display panel having anti-scrape layer of claim 1, wherein said first transparent substrate comprises:
a glass substrate, disposed on said display apparatus;
a first circuit layer, disposed on said glass substrate; and
a first conductive film, disposed on said first circuit layer.

7. The resistive touch display panel having anti-scrape layer of claim 1, wherein said second transparent substrate comprises:
a second conductive film, disposed on said adhesive layer;
a second circuit layer, disposed on said second conductive film; and
a protection film, disposed on said second circuit layer.

8. The resistive touch display panel having anti-scrape layer of claim 1, and further comprising a controller, disposed on one side of said display apparatus, and connected electrically to said first transparent substrate and said second transparent substrate.

9. The resistive touch display panel having anti-scrape layer of claim 1, wherein a spacing zoom is disposed between said first transparent substrate and said second transparent substrate.

10. The resistive touch display panel having anti-scrape layer of claim 1, wherein said second transparent substrate further comprises a plurality of spacers disposed on said second transparent substrate.
